(19) United States
(12) Patent Application Publication
(10) Pub. No.: US 2013/0034623 A1
(43) Pub. Date: Feb. 7, 2013

(54) Substrate-Molding Apparatus

(71) Applicants: Yang-Kuao Kuo, Taoyuan County (TW); Ching-Hui ChiangLin, Taoyuan County (TW); Te-Po Liu, Taoyuan County (TW)

(72) Inventors: Yang-Kuao Kuo, Taoyuan County (TW); Ching-Hui ChiangLin, Taoyuan County (TW); Te-Po Liu, Taoyuan County (TW)

(73) Assignee: Chung-Shan Institute of Science and Technology, Armaments, Bureau, Ministry of National Defense, Taoyuan County (TW)

(21) Appl. No.: 13/237,087

(22) Filed: Sep. 20, 2011

(30) Foreign Application Priority Data
Aug. 4, 2011 (TW) 100127703

(51) Int. Cl. B29C 43/50

(52) U.S. Cl. 425/422

(57) ABSTRACT

Disclosed is a substrate-molding apparatus. The substrate-molding apparatus includes a shell, a mold movably located in the shell, an upper pressing disc movably located in the mold, and a lower pressing disc movably located in the mold. The shell includes an internal space defined therein and two open ends in communication with the internal space. The mold includes an internal space defined therein. The upper pressing disc includes at least one cutout defined in the edge thereof. Powder is filled in the internal space of the mold. The powder is pressed and molded by the upper pressing disc driven by hydraulic pressure. The molded product is removed from the mold by hydraulic pressure. Thus, the removal of the molded product from the mold is easy and fast. The yield is high. Moreover, the substrate-molding apparatus can be used repeatedly.

### BACKGROUND OF INVENTION

1. Field of Invention

The present invention relates to a substrate and, more particularly, to an efficient and reliable apparatus for molding powder of a predetermined material into a substrate.

2. Related Prior Art

To make an aluminum nitride substrate, aluminum nitride powder may be filled in a mold and then molded, under hydraulic pressure, into an aluminum nitride substrate with a predetermined shape, size and strength. A molding process is a very important one in the ceramic industry.

The aluminum nitride substrate is stripped from the mold for further processing and later use. A stripping process is a more important one in the ceramic industry. A proper stripping process is important to protect the aluminum nitride substrate from dents, cracks and/or peeling and to therefore improve the yield.

Conventionally, a release agent is used to facilitate the striping of the aluminum nitride substrate from the mold in the stripping process. The provision of the release agent is however an additional step that takes extra time. Moreover, the release agent might cause the aluminum nitride substrate to deteriorate.

The present invention is therefore intended to obviate or at least alleviate the problems encountered in prior art.

### SUMMARY OF INVENTION

It is the primary objective of the present invention to provide an efficient and reliable apparatus for molding a substrate.

To achieve the foregoing objectives, the substrate-molding apparatus includes a shell, a mold and upper and lower pushers. The shell includes a space defined therein. The mold is movably located in the space of the shell. The mold includes a cylindrical space defined therein. The upper pusher is movably located in the cylindrical space of the mold. The upper pusher includes at least one slit defined in the periphery thereof. The lower pusher is movably located in the space of the shell and abutted against the bottom of the mold.

In an aspect, the shell may be made of stainless steel.

In another aspect, the space of the shell is a frusto-conical space that gets tapered as it extends downward.

In another aspect, the mold includes a frusto-conical external face corresponding to the frusto-conical space of the shell.

In another aspect, the mold includes at least three planks located against one another and each formed with an arched internal face and a semi-conical external face. The arched internal faces of the planks together define the cylindrical space of the mold. The semi-conical external faces of the planks together form the frusto-conical external face of the mold.

In another aspect, the mold is made of stainless steel.

In another aspect, the upper pusher is formed with a convex lower face.

In another aspect, the substrate-molding further includes a piece of release paper in contact with the upper pusher and another piece of release paper in contact with the lower pusher.

In another aspect, the pieces of release paper are duo-sided reflector paper.

In another aspect, aluminum nitride powder can be filled and molded in the cylindrical space of the mold.

Other objectives, advantages and features of the present invention will be apparent from the following description with reference to the attached drawings.

### BRIEF DESCRIPTION OF DRAWINGS

The present invention will be described via detailed illustration of the preferred embodiment with reference to the drawings wherein:

FIG. 1 is a perspective view of a substrate-molding apparatus in accordance with the preferred embodiment of the present invention;

FIG. 2 is an exploded view of the substrate-molding apparatus shown in FIG. 1;

FIG. 3 is a cross-sectional view of the substrate-molding apparatus shown in FIG. 1; and

FIG. 4 is a perspective view of the substrate-molding apparatus in another position than shown in FIG. 1.

### DETAILED DESCRIPTION OF PREFERRED EMBODIMENT

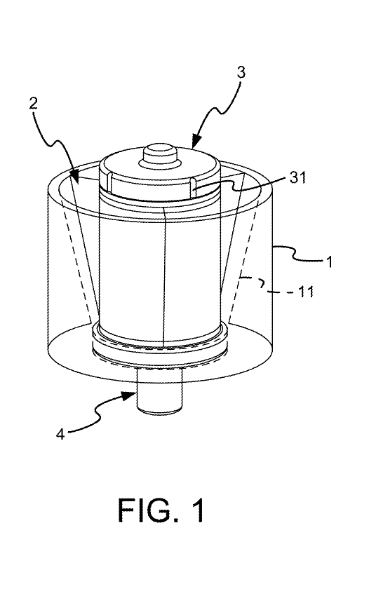

With reference to FIG. 1, there is shown a substrate-molding apparatus in accordance with the preferred embodiment of the present invention. The substrate-molding apparatus includes a shell 1, a mold 2, an upper pusher 3 and a lower pusher 4.

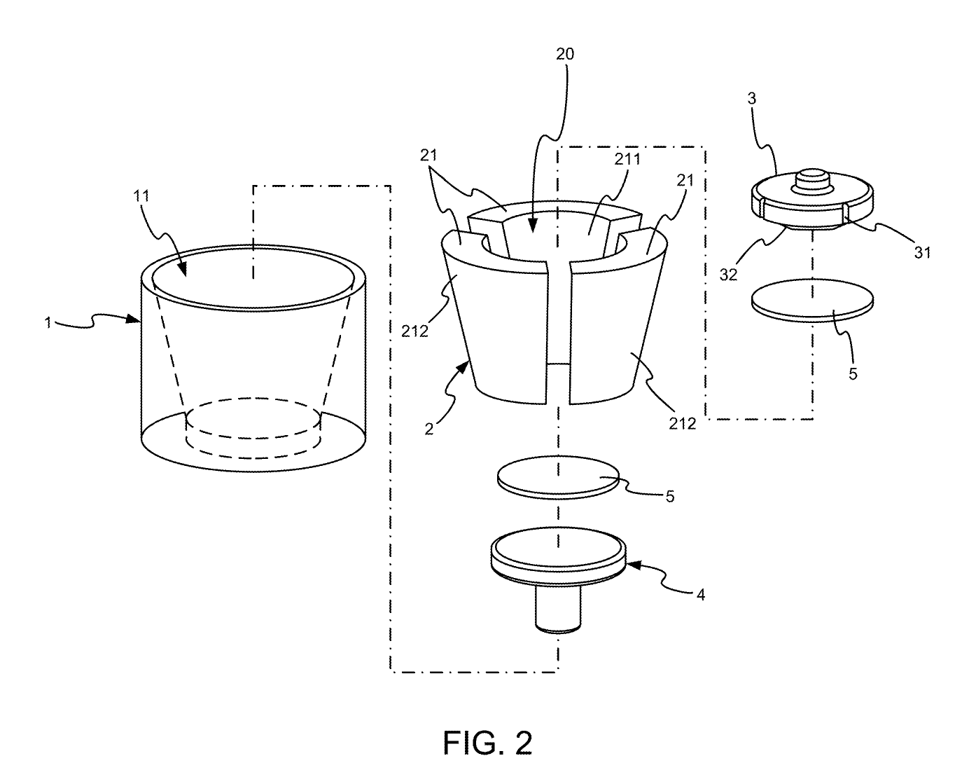

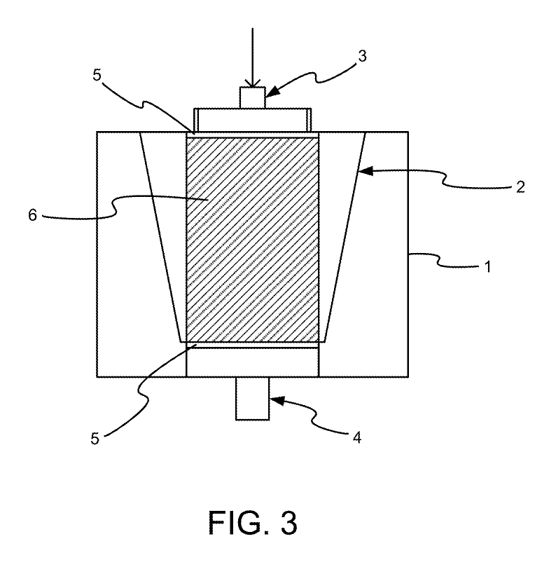

With reference to FIGS. 2 and 3, the shell 1 may be made of stainless steel. The shell 1 includes a frusto-conical space 11 defined therein. The frusto-conical space 11 includes an upper open end and a lower open end. The frusto-conical space 11 shrinks as it extends downward. That is, the upper open end of the frusto-conical space 11 is larger than the lower end of the frusto-conical space 11. As shown in FIG. 3, the wall of frusto-conical space 11 extends at an angle of 2 degrees from a vertical line.

The mold 2 may be made of stainless steel. The mold 2 is movably located in the frusto-conical space 11 defined in the shell 1. The mold 2 includes a cylindrical space 20 defined therein. The mold 2 consists of at least three planks 21 arranged against one another (or “side by side”). Each of the planks 21 is formed with an arched internal face 211 and a semi-conical external face 212. The arched internal faces 211 of planks 21 together form the wall of the cylindrical space 20. The semi-conical external faces 212 of the planks 21 together form a frusto-conical face corresponding to the wall of the frusto-conical space 11 defined in the shell 1.

The upper pusher 3 is movably located in the space 20 cylindrical space defined in the mold 2. The upper pusher 3 includes at least one slit 31 defined in the periphery thereof. The upper pusher 3 includes a convex lower face 32 that extends at an angle of 1 degree from a horizontal plane as shown in FIG. 3.

The lower pusher 4 is movably located in the frusto-conical space 11 defined in the shell 1. The lower pusher 4 is located against the bottom of the mold 2, thus closing the lower open end of the cylindrical space 20 defined in the mold 2. A piece of release paper 5 is provided on the bottom of the upper pusher 3 while another piece of release paper 5 is provided on the top of the lower pusher 4. The release paper 5 may be duo-sided reflector paper.

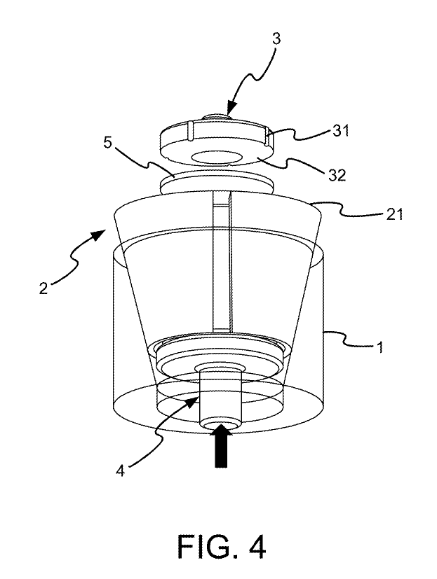

With reference to FIG. 4, in use, the lower pusher 4 is located in a lower portion of the frusto-conical space 11 defined in the shell 1. The planks 21 of the mold 2 are arranged against one another before they are located in the frusto-conical space 11 defined in the shell 1. The lower pusher 4 is used to close the lower open end of the cylindrical space 20 defined in the mold 2. The cylindrical space 20 defined in the mold 2 is filled with powder 6 aluminum nitride or any other proper material. The upper pusher 3 is located in the cylindrical space 20 defined in the mold 2 and the convex lower face 32 of the upper pusher 3 is located on the aluminum nitride powder 6. One of the pieces of release paper 5 is located between the upper pusher 3 and the aluminum nitride powder 6 while the other piece of release paper 5 is located between the lower pusher 4 and the aluminum nitride powder 6 to prevent the aluminum nitride powder 6 from contact with the pushers 3 and 4 as hydraulic pressure is exerted on the upper pusher 3 against the lower pusher 4. Thus, the top and bottom of an aluminum nitride substrate are planar. The hydraulic pressure is exerted on the upper pusher 3 at a plurality of stages. Repeatedly, the hydraulic pressure is exerted on the upper pusher 3 and stopped so that the aluminum nitride powder 6 is made an aluminum nitride with a desired height. Gases produced in the hydraulic process are released from the mold 2 through the slits 31 defined in the upper pusher 3. The lower pusher 4 is pushed from the bottom so that the mold 2 is removed from the frusto-conical space 11 defined in the shell 1 before the planks 21 are separated from one another. Thus, the aluminum nitride substrate is released from the mold 2.

As described above, the powder 6 is located in the space defined in the cylindrical space 20 defined in the mold 2. Hydraulic pressure is exerted on the upper pusher 3 periodically to mold the powder 6. Then, hydraulic pressure is exerted on the lower pusher 4 so that the mold 2 is moved out of the shell 1. Finally, the planks 20 of the mold 2 are moved from one another so that the aluminum nitride substrate is quickly released from the mold 2, the yield is increased, and the apparatus can be used repeatedly.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A substrate-molding apparatus including:
a shell 1 including a space 11 defined therein;
a mold 2 movably located in the space 11 of the shell 1, wherein the mold 2 includes a cylindrical space 20 defined therein;
an upper pusher 3 movably located in the cylindrical space 20 of the mold 2, wherein the upper pusher 3 includes at least one slit 31 defined in the periphery thereof; and
a lower pusher 4 movably located in the space 11 of the shell 1 and abutted against the bottom of the mold 2.

2. The substrate-molding apparatus in accordance with claim 1, wherein the shell 1 is made of stainless steel.

3. The substrate-molding apparatus in accordance with claim 1, wherein the space 11 of the shell 1 is a frusto-conical space that gets tapered as it extends downward.

4. The substrate-molding apparatus in accordance with claim 3, wherein the mold 2 includes a frusto-conical external face corresponding to the frusto-conical space 11 of the shell 1.

5. The substrate-molding apparatus in accordance with claim 4, wherein the mold 2 includes at least three planks 21 located against one another and each formed with an arched internal face 211 and a semi-conical external face 212, wherein the arched internal faces 211 of the planks 21 together define the cylindrical space 20 of the mold 2, wherein the semi-conical external faces 212 of the planks 21 together form the frusto-conical external face of the mold 2.

6. The substrate-molding apparatus in accordance with claim 1, wherein the mold 2 is made of stainless steel.

7. The substrate-molding apparatus in accordance with claim 1, wherein the upper pusher 3 is formed with a convex lower face 32.

8. The substrate-molding apparatus in accordance with claim 1, further including a piece of release paper 5 in contact with the upper pusher 3 and another piece of release paper 5 in contact with the lower pusher 4.

9. The substrate-molding apparatus in accordance with claim 1, wherein the pieces of release paper 5 are duo-sided reflector paper.

10. The substrate-molding apparatus in accordance with claim 1, wherein aluminum nitride powder 6 can be filled and molded in the cylindrical space 20 of the mold 2.
